(19) United States
(12) Patent Application Publication
(10) Pub. No.: US 2018/0084811 A1
(43) Pub. Date: Mar. 29, 2018

(54) NOVEL AND USEFUL EDIBLE SALT AND METHODS OF USE AND PRODUCTION THEREOF

(71) Applicant: E.K. SALT LTD., HERZLIA (IL)

(72) Inventor: Eitan SHALOM, GIVAT ELA (IL)

(73) Assignee: E.K. SALT LTD., HERZLIA (IL)

(21) Appl. No.: 15/562,269

(22) PCT Filed: Mar. 28, 2016
(86) PCT No.: PCT/IL2016/050332

§ 371 Date: Sep. 27, 2017

Related U.S. Application Data
(60) Provisional application No. 62/139,802, filed on Mar. 30, 2015.

(51) Int. Cl. A23L 27/40; A23P 20/10

(52) U.S. Cl. CPC A23L 27/40; A23V 2002/00; A23P 20/10

(57) ABSTRACT

A food additive useful as a table salt substitute in the form of a fine powder of a mixture of salts and acids ratio of Sodium, Potassium, Calcium and Magnesium elements in accordance with the recommended daily allowance for said elements issued by the American Food and Drug Administration

### REFERENCE TO RELATED APPLICATION

This application claims priority from U.S. Provisional Pat. Appl. No. 62/139,802, filed 30 Mar. 2015.

### FIELD OF THE INVENTION

The present invention is directed towards substitutes for edible salt for use in ready cooked or preserved foods and food processing. More particularly, the present invention provides useful alternatives to edible salt with added functionalities.

### BACKGROUND OF THE INVENTION

### Benefits of Salt in the Diet and Food Preparation.

Salt is essential to the human diet and Sodium Chloride Salt is a very common component in modern food preparation, both industrial and domestic. Salt plays a role in water retention, muscle contraction, and contains nutrients vital to digestive function. Salt in moderation is very important to the diet, and of course also plays a role in improving the taste of foods and stimulating appetite. Salt is a common preservative in a myriad of food technologies, processes and cooking and culinary uses.

Salt is important to good nutritional status. Too little can cause disturbances in tissue-water and acid-base balance, which is important to good nutrition. A certain amount of water retention is necessary to maintain the appropriate electrolyte balance, including salt, to help carry out electrical impulses that control many of our bodies' functions. Electrolytes trigger the thirst mechanism, causing us to consume adequate amounts of water. With this water, the kidneys are able to keep the appropriate amount of electrolytes in the bloodstream. The amount of water our bodies retain also impacts blood pressure.

Salt is required for correct nerve function, and it stimulates muscle contraction; this helps prevent muscles from cramping. Salt also keeps calcium and other minerals in the bloodstream and stimulates the adrenal glands. Salt is also very important in the prevention of heat prostration and sunstroke.

Salt contains nutrients vital to the digestive system and is vital to the processes of digestion and absorption. Salt activates an enzyme in the mouth called salivary amylase. At this point, the salt allows taste buds to taste the food. Salt also plays a role in digestion by helping to break down food and enables production of hydrochloric acid. Hydrochloric acid is a digestive secretion, which lines the stomach walls. The salt derived hydrochloric acid protects the stomach walls from being digested by the digestive enzymes, so that the digestive enzymes fulfill the function of digesting food alone.

### Lack of Salt.

Sodium deficiency is a health condition where a body fails to receive an adequate supply of sodium. Such deficiency can become extremely prevalent in excessive temperatures, which cause the body to perspire heavily and patterns of dehydration set in. Sodium deficiency can lead to shock if the blood pressure decreases too severely.

### Excess of Salt.

There is of course a great deal of knowledge indicating however, that too much salt in the diet (very prevalent in developed economies and societies) can lead to high water retention and hypertension. Overall, salt is generally nontoxic to adults, provided it is excreted properly. The maximum amount of sodium that should be incorporated into a healthy diet should range from 2,400-3,000 mg/day.

High levels of Sodium intake have been found to contribute to a number of unwanted health issues, mainly high blood pressure which can lead to an increased risk of heart disease, kidney disease and stroke.

The average intake of Sodium by American adults is 3300 mg per day. This level is too high compared with FDA recommendations which suggest reducing the Sodium intake to 1500 mg per day for populations which have been shown to be more susceptible to the blood pressure increasing effect of Sodium, such as people which already have high blood pressure, diabetes, chronic kidney disease and people over the age of 51.

In WO/2009/099466 (Vadlamani et al) compositions are suggested for reduction of sodium in food products. In US 20040224076 A1, a dietetic composition in the form of a salt substitute for table salt is suggested.

The food industry has long attempted to provide formulations with ingredients that can replicate the purpose of salt, regarding flavour or functional properties without the sodium content, or the addition of ingredients that have been subjected to advanced technologies, i.e. modified sodium chloride.

Alternatively there are a range of techniques that have or can be implemented into food manufacturing in many sectors, including reduction by stealth and altering of the food matrix. There still remains a long felt unmet need to provide improved salts for human consumption.

### SUMMARY OF THE PRESENT INVENTION

Compositions, means and methods are provided for a food additive useful as a table salt substitute and an industrial food processing product which can advantageously be a substitute for salt in the form of a fine powder of a mixture of salts and acids. The ratio of Sodium, Potassium, Calcium and Magnesium elements is in accordance with the recommended daily allowance for said elements issued by the American Food and Drug Administration, wherein said ratio of said elements are approximately, by weight percentage: 60.6% Potassium, 19.4% Sodium, 15.5% Calcium, 4.5% Magnesium. Further details are herein disclosed.

### BRIEF DESCRIPTION OF THE PRESENT INVENTION

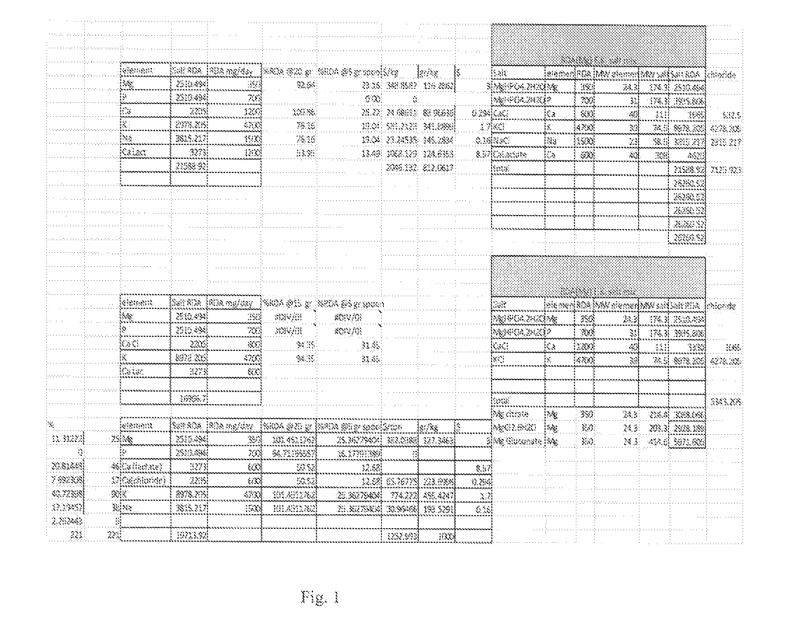

FIG. 1 illustrates aspects of the present invention.

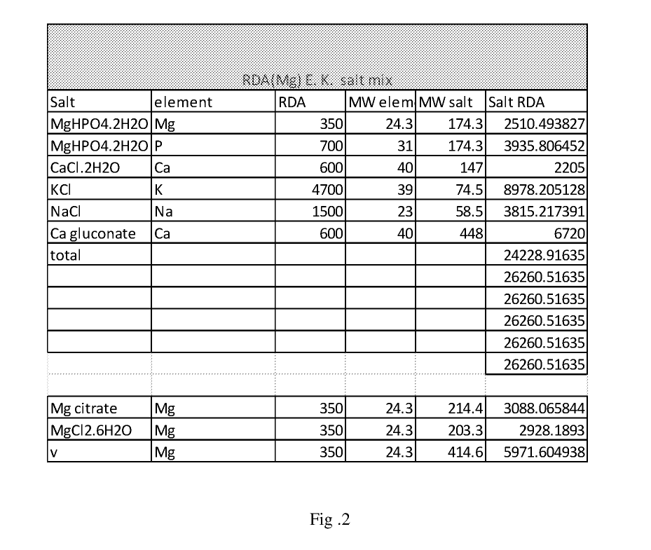

FIG. 2 illustrates aspects of the present invention.

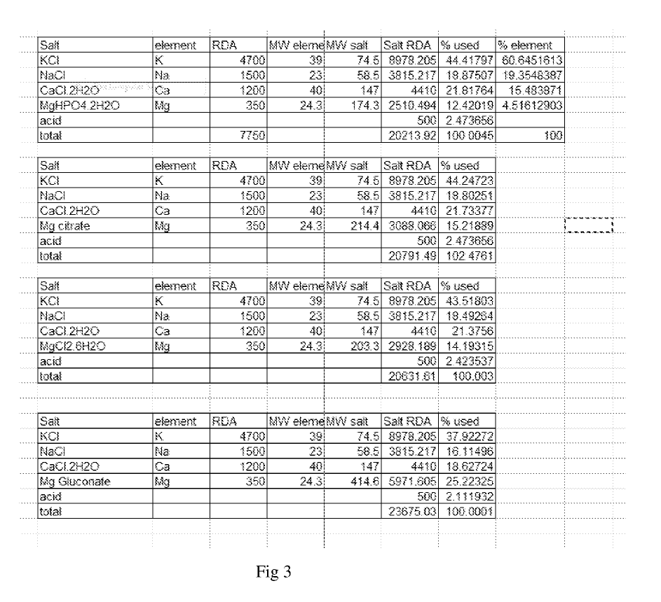

FIG. 3 illustrates aspects of the present invention.

FIG. 4 illustrates aspects of the present invention.

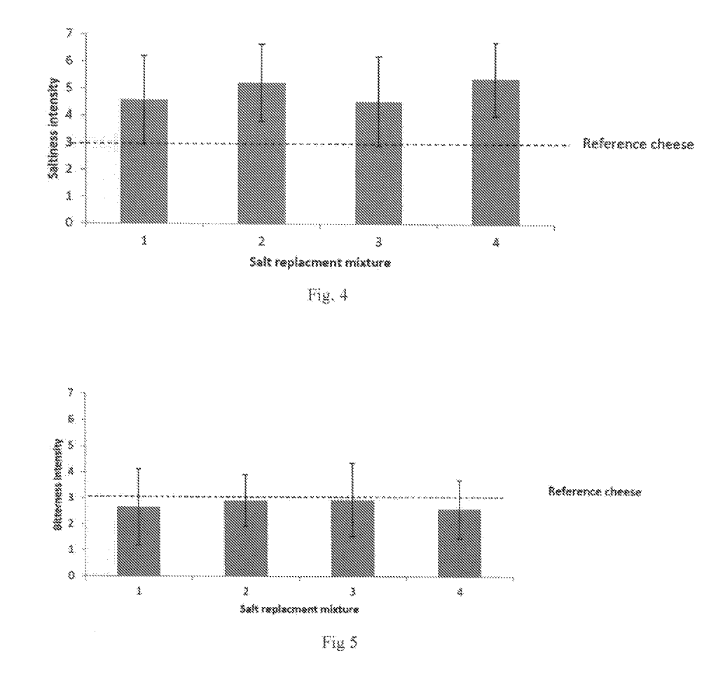

FIG. 5 illustrates aspects of the present invention.

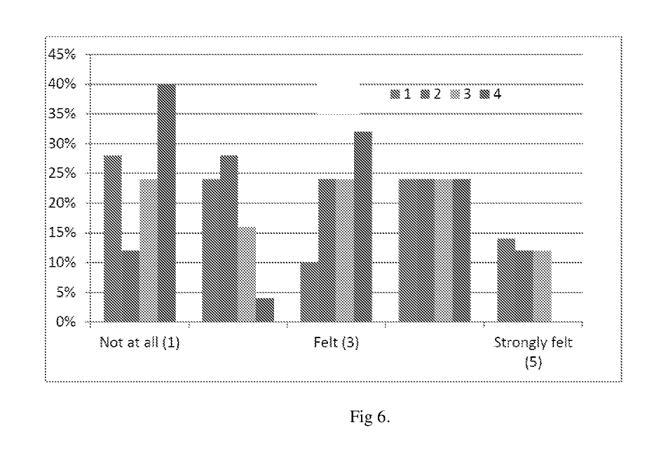

FIG. 6 illustrates aspects of the present invention.

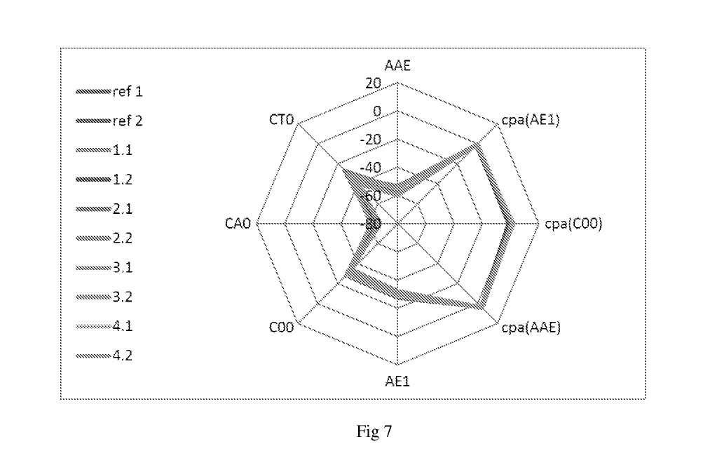

FIG. 7 illustrates aspects of the present invention.

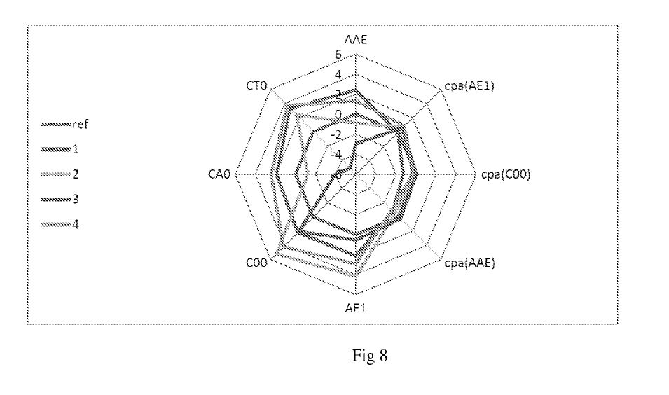

FIG. 8 illustrates aspects of the present invention.

FIG. 9 illustrates aspects of the present invention.

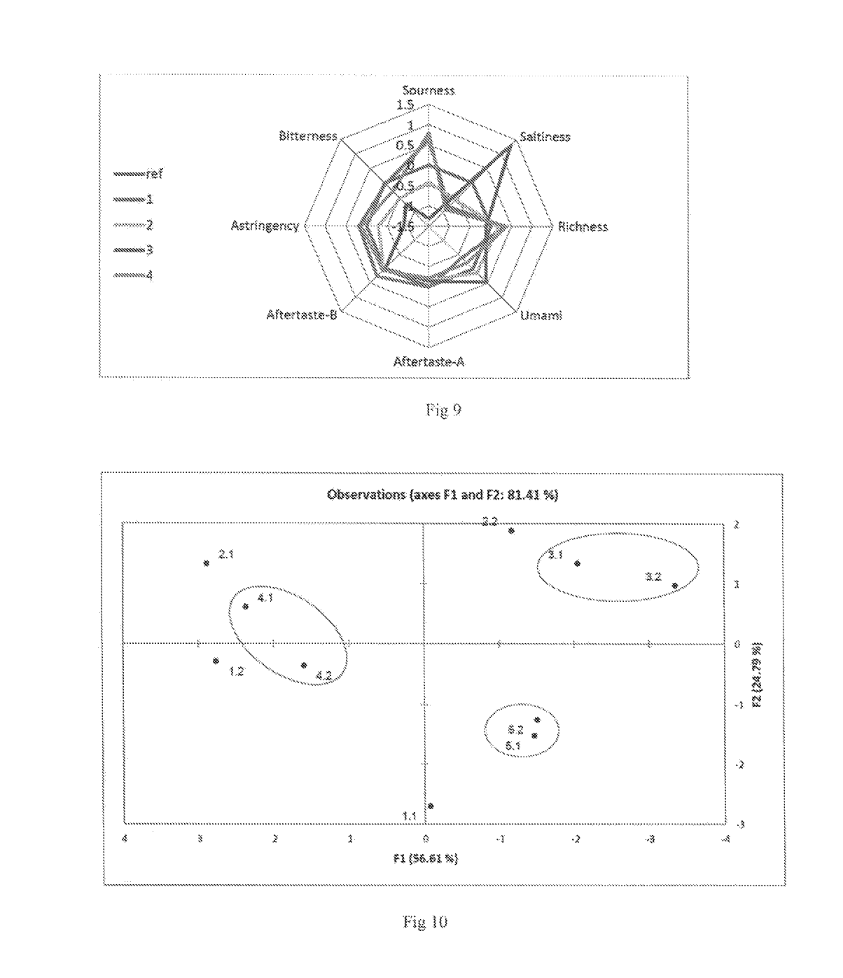

FIG. 10 illustrates aspects of the present invention.

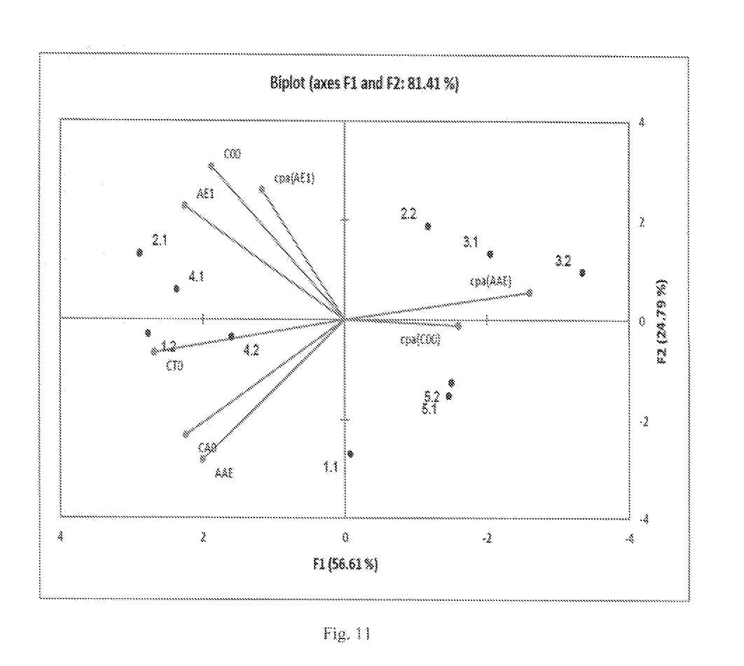

FIG. 11 illustrates aspects of the present invention.

FIG. 12 illustrates aspects of the present invention.

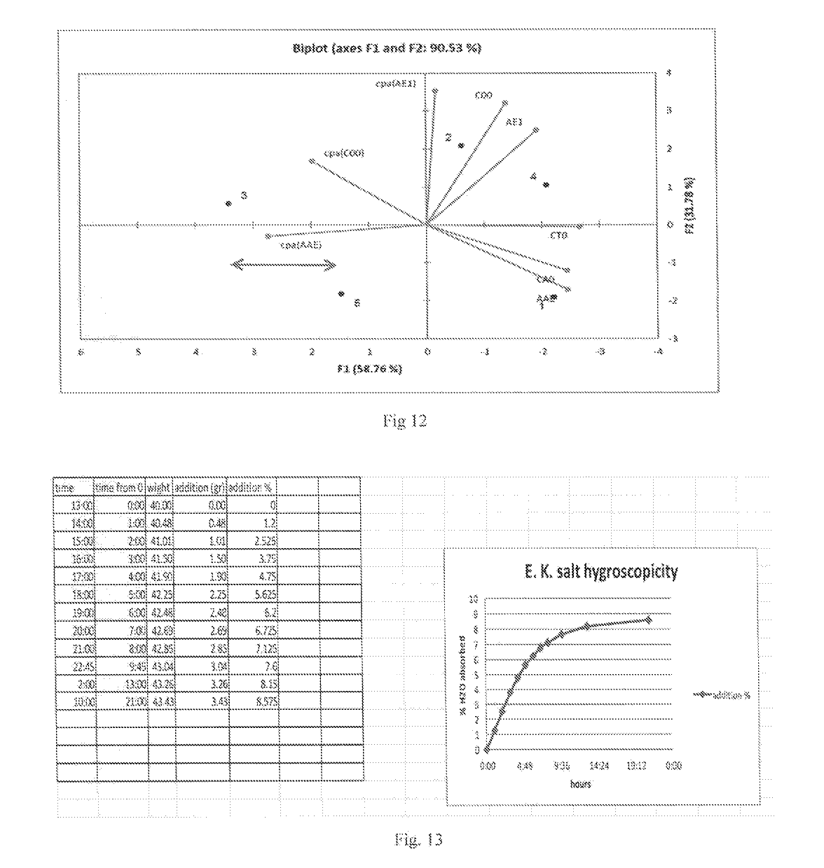

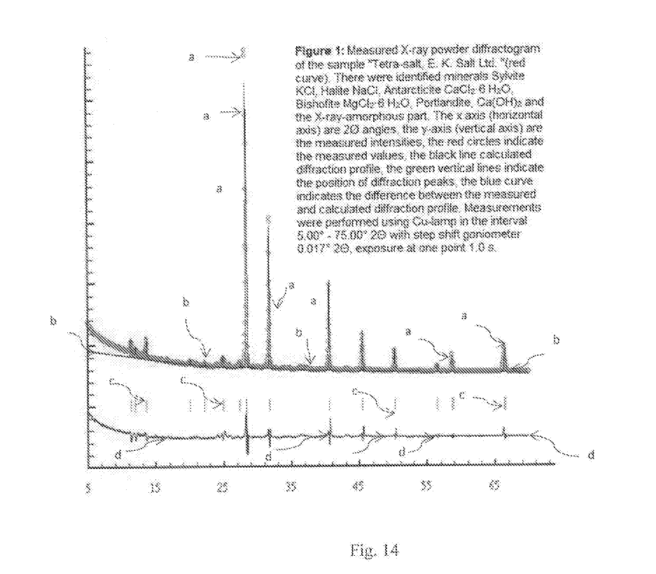

FIG. 13 illustrates aspects of the present invention.

FIG. 14 illustrates aspects of the present invention.

### DETAILED DESCRIPTION OF THE PRESENT INVENTION

The description is provided, alongside all chapters of the present invention, so as to enable any person skilled in the art to make use of said invention. The best modes contemplated by the inventor of carrying out this invention have been set forth herein. Various modifications, however, remain apparent to those skilled in the art, since the generic principles of the present invention have been defined specifically to provide means and methods of providing novel salt mixtures (salt substitutes) which can be used instead of regular salt (Sodium Chloride). The novel salt mixtures herein referred to not only provide a viable alternative to salt in terms of taste, but fulfill recommended daily intake requirements of important elements when used as intended and indicated, as food additives in food flavoring and food processing.

It is herein acknowledged that the novel salt mixtures of the present invention are useful as salt substitutes for regular table salt and as food additives.

Sodium is not the only common element which plays an important role in the human diet. Calcium is necessary for bone, tooth and tissue maintenance, as well as for muscle and nerve function. Prolonged lack of calcium can result in rickets in children and osteoporosis in adults. Both of these conditions cause weakened bones and result in an increased risk for fractures. Calcium supplements can be used to help reverse the symptoms of calcium deficiencies. Because of the severity of these conditions, there are many benefits to supplementing diet with calcium. Results reported indicate that calcium is absorbed better from calcium lactate than from calcium gluconate in man as judged by three separate sets of analytical data, i.e., the changes in stool calcium analyses and calcium balances, in fecal 47Ca excretions and in 47Ca plasma levels. The differences in the results obtained with the 2 calcium salts for the group of patients are statistically significant for each of these criteria.

Some embodiments of the present invention containing an easily absorbable source of calcium in the form of Calcium lactate, which has been shown to be an improved source of dietary calcium, due to its easier absorption in the gut. This has been recorded, inter cilia, in the article HERTA SPENCER, JOSEPHINE SCHECK, ISAAC LEWIN AND JOSEPH SAMACHSON Metabolic Section, Veterans Administration Hospital, Hines, Ill.

Comparative Absorption of Calcium from Calcium Gluconate and Calcium Lactate in Man

In J. Nutrition 89; 66 page 283-292, which is herein incorporated in its entirety.

The core of the present invention is an optimized unique series of mixtures which can be used domestically, in culinary institutions, meal preparation and in all manner of food technologies. It will be seen that the embodiments of the present invention provide an acceptable new type of salt.

The salt substitute of the present invention is a proprietary mixture of salts containing potassium, sodium calcium and magnesium balanced according to the FDA recommended daily intake, without affecting the salt taste.

### Process for Manufacturing the Salt Substitute of the Present Invention.

The salt substitute of the present invention is a crystalline mixture of 7 components. Some of the components are in the hydrated form: (Ca (lactate).5H2O, MgHPO4.2H2O, MgCl2.6H2O)

After heating to 110 deg. C, the water is lost. Heating is performed in a closed vessel, until slurry is formed. The slurry is dried, and the mixture is less hygroscopic than the components.

The slurry may also be put through spray drying process to obtain the crystalline mixture of the salt substitute.

### Experimental Data:

7 ingredients of table #1 were mixed in a reactor, and placed in a tray. The tray is covered with a tight cover, and placed in an oven at 110 Deg. C for 1 hour.

The cover was removed and the slurry thoroughly mixed and spread in the tray.

The temperature was raised to 130 Deg. C, and the open tray placed in the oven for 1.30 hours.

The tray was removed and the mixture of the crystals crushed and sieved to the desired mesh.

FIG. 13 illustrates the hygroscopic data obtained from the sample.

TABLE 1
Components of salt substitute

[symbol]

| H₂O | | | | MW | | | | % | dry |
|---|---|---|---|---|---|---|---|---|---|
| MW | Salt | element | RDA | element | MW salt | Salt RDA | % used | element | weight |
| | KCl | K | 4700 | 39 | 74.50 | 8978.21 | 39.79 | 60.65 | 8978.21 |
| | NaCl | Na | 1500 | 23 | 58.50 | 3815.22 | 16.91 | 19.35 | 3815.22 |
| | CaCl | Ca | 600 | 40 | 111.00 | 1665.00 | 7.38 | 7.74 | 1665.00 |
| 90 | Ca | Ca | 600 | 40 | 308 | 4620.00 | 20.47 | 7.74 | 3270.00 |
| | (lactate)•5H2O | | | | | | | | |
| 36 | MgHPO4•2H2O | Mg | 60 | 24.3 | 174.30 | 430.37 | 1.91 | 0.77 | 341.48 |
| 108 | MgCl2•6H2O | Mg | 290 | 24.3 | 203.30 | 2426.21 | 10.75 | 3.74 | 1137.33 |
| | acid citric | | | | | 630.00 | 2.79 | 0.00 | 630.00 |
| | total | | 7750 | | | 22565.01 | 100.00 | 100.00 | 19837.23 |

[symbol]

indicates data missing or illegible when filed

TABLE 2
Formulation for 15% sodium reduction according to WHO minimal
requirements, and E.K. Salt RDI balance of the macroelements (excluding sodium)

[symbol]

| | | | MW | | | | % |
|---|---|---|---|---|---|---|---|
| Salt | element | use | element | MW salt | Salt use | % used | element |
| KCl | K | 4700 | 39 | 74.5 | 8978.21 | 7.2974 | 9.9470899 |
| NaCl | Na | 41000 | 23 | 58.5 | 104283 | 84.76 | 86.772487 |
| CaCl | Ca | 600 | 40 | 111 | 1665 | 1.3533 | 1.2698413 |
| Ca (lactate) | Ca | 600 | 40 | 308 | 4620 | 3.7551 | 1.2698413 |
| MgHPO4•2H2O | Mg | 60 | 24.3 | 174.3 | 430.37 | 0.3498 | 0.1269841 |
| Mg citrate | Mg | 0 | 24.3 | 214.4 | 0 | 0 | 0 |
| MgCl2•6H2O | Mg | 290 | 24.3 | 203.3 | 2426.21 | 1.972 | 0.6137566 |
| acid citric | | | | | 630 | 0.5121 | 0 |
| total | | 47250 | | | 123032 | 100 | 100 |

Formula with 85% NaCl by requirement of health authorities (salt substitute 15%, NaCl 85%) [symbol]
indicates data missing or illegible when filed

The present invention provides a salt substitute having the effect of taste improvement and palatability similar to that of the traditional Sodium Chloride salt but comprising of a much reduced Sodium content with a component of Calcium Lactate, easily absorbable form of Calcium. It is herein envisaged that the substitution of the salt substitute of the present invention may be of benefit to lowering dietary sodium and thereby blood pressure, as well as providing easily absorbable calcium which may be of benefit to prevent or rectify calcium deficiencies.

Herein are described non limiting examples of novel salt substitutes of the present invention.

Specific embodiments of the invention include the following homogenous mixtures which form tasty salting spices and are given below in bulk quantities for non-limiting purposes.

A specific embodiment of the present invention is recited below:

Product Details

Product name POTASSIUM CHLORIDE mixture
Article number: 5552870
Application of the substance/the preparation: food additive

POTASSIUM CHLORIDE CAS No. 7447-40-7 (30-60%)
EINECS Number: 231-211-8
SODIUM CHLORIDE CAS No. 7647-14-5 (10-30%)
EINECS Number: 231-598-3
CALCIUM CHLORIDE CAS No. 1043-52-4
EINECS Number: 233-140-8 (5-15%)
CALCIUM LACTATE CAS No. 814-80-2
EINECS Number: 212-406-7 (10-30%)
MAGNESIUM CHLORIDE CAS No. 7786-30-3 (4-20%)

### General Description: Free Flowing White Crystalline Material

pH (5% solution): 5-7
   Solubility @ 20 Deg. C: >7%.
   Insoluble matter: <0.05%
   Heavy metals (as Pb)<10 ppm

### Arsenic <2 ppm

### Fluoride <5 ppm

### Granularity (95%)<300μ□

Examples 1-9 are non-limiting examples of the salt substitute of the present invention used in the various trials and experiments recited herein. They can be used as salt substitutes and/or food additives as required.

### Example 1

Potassium chloride: 89.78 kg
Sodium chloride: 38.15 kg
Calcium chloride: 33.30 kg
Magnesium phosphate: 25.10 kg
Citric acid: 5 kg

### Example 2

Potassium chloride: 89.78 kg
Sodium chloride: 38.15 kg
Calcium lactate: 32.73 kg
Calcium chloride: 16.65 kg
Magnesium phosphate: 25.10 kg
Citric acid: 5 kg

### Example 3

Potassium chloride: 89.78 kg
Sodium chloride: 38.15 kg
Calcium chloride: 33.30 kg
Magnesium phosphate: 25.10 kg
Ascorbic acid: 5 kg

### Example 4

Potassium chloride: 89.78 kg
Sodium chloride: 38.15 kg
Calcium gluconate: 64.50 kg
Calcium chloride: 16.65 kg
Magnesium phosphate: 25.10 kg
Citric acid: 5 kg

### Example 5

Potassium chloride: 44.89 kg
Potassium tartarate: 136.30
Sodium chloride: 38.15 kg
Calcium gluconate: 64.50 kg
Calcium chloride: 16.65 kg
Magnesium phosphate: 25.10 kg
Citric acid: 5 kg

### Example 6

Potassium chloride: 44.89 kg
Potassium tartarate: 136.30
Sodium chloride: 38.15 kg
Calcium gluconate: 64.50 kg
Calcium chloride: 16.65 kg
Magnesium phosphate: 25.10 kg
Malic acid: 5 kg

### Example 7

Potassium chloride: 89.78 kg
Sodium chloride: 38.15 kg
Calcium gluconate: 64.50 kg
Calcium chloride: 16.65 kg
Magnesium citrate: 30.88 kg
Citric acid: 5 kg

### Example 8

Potassium chloride: 89.78 kg
Sodium chloride: 38.15 kg
Calcium lactate: 32.73 kg
Calcium chloride: 16.65 kg
Magnesium chloride: 29.28 kg,
Malic acid: 5 kg

### Example 9

Potassium chloride: 89.78 kg
Sodium chloride: 38.15 kg
Calcium lactate: 32.73 kg
Calcium chloride: 16.65 kg
Magnesium gluconate: 59.71 kg
Malic acid: 5 kg

### Analysis:

X ray powder diffractogram of a sample of the present invention was carried out, results illustrated in table 3 below, and as described and illustrated in FIG. 14.

| | |
|---|---|
| Laboratory sample ID: | PR1614792/001 |

| Analyte | Mineral | Result | MU |
|---|---|---|---|
| KCl | Sylvite | 41.6% | ±15 |
| NaCl | Halite | 20.7% | ±15 |
| CaCl₂•6 H₂O | Antarcticite | 11.1% | ±30 |
| MgCl₂•6 H₂O | Bishofite | 3.1% | ±40 |
| Ca(OH)₂ | Portlandite | 14.1% | ±30 |
| REST | | 9.7% | n/a |

The measurement uncertainty (MU) is expressed as an estimate of expanded relative measurement uncertainty (in percents) with coverage factor k = 2, representing 95% confidence level.

FIG. 14 references a measured X-ray powder diffractogram of the sample of the present invention.

The horizontal x-axis are 2Ø angles, the vertical y axis are the measured intensities, the small circles (some marked a in FIG. 14) indicate the measured values, the black line (marked b in FIG. 14) calculated diffraction profile, the vertical lines (marked c in FIG. 14) indicate the position of diffraction peaks, and the curve (marked d in FIG. 14) indicates the difference between measured and calculated diffraction profile.

Measurements were performed using Cu-lamp in the interval 5.00°-75.00° 2θ with step shift goniometer 0.017° 2θ, exposure at one point 1.0 s

In addition, the food additive of the present invention contains a high level of Potassium which may contribute to countering the effect of Sodium on blood pressure.

The food additive suggested consists of a heterogenic mixture of powdered salts and acids that can be used both in an industrial process and in domestic food preparation.

The composition of the mixture in the food additive is based on the American Food and Drug Administration recommendation of daily intake of four elements: Sodium, Potassium, Calcium and Magnesium. This recommendation is: Potassium—4700 mg/day, Sodium—1500 mg/day, Calcium—1200 mg/day and Magnesium—350 mg/day.

These values have been converted to a weight percentage ratio as follows: 60.6% Potassium, 19.4% Sodium, 15.5% Calcium, and 4.5% Magnesium.

FIG. 1, FIG. 2 and FIG. 3 are exemplary tables providing further details of various compositions of the present invention. It is herein acknowledged that the exemplary tables in FIG. 1 and FIG. 2 show the Salts, Elements, Elemental Recommended Daily Allowance (RDA), Molecular Weight of elements, Molecular Weight of Salt, Salt RDA, % of RDA used, % element.

Elements of the present invention may be in the form of the following salts: Chloride, Phosphate, Lactate, Citrate, Gluconate, Ascorbate, and Tartarate.

The acids contained in the mixture serve as flavor correctors and may be Citric acid, Ascorbic acid, Malic acid or a mixture of them.

The acid component is 1-3 weight percent of the entire mixture.

The use of the salt substitute compositions of the present invention is referenced to be useful as any of a replacement for table salt, as a seasoning, food substitute, food additive, flavouring, aid for water retention and preservative).

The use of the salt substitute composition of the invention is referenced to be useful in many industrial food recipes, formulations and processes:

Salad sauce, Ketchups, soups, soft cheeses, hard cheeses, cream cheese, breads, Tehina (sesame sauce), meat and meat products, fish and fish products, pickled cabbage and pickled vegetables and many other products.

It is herein acknowledged that compositions of the present invention can be provided with or without added Iodine or iodine compounds.

It is herein acknowledged that compositions of the present invention can be provided with or without added anti caking agents.

It is herein acknowledged that other magnesium compounds may be, in some embodiments of the present invention, substituted for Magnesium phosphate substantially or in part by any magnesium compound selected in the formulation of example 1, from the group consisting of magnesium citrate, 15.22% by weight, MgCl2.6H2O 14.19% by weight, or Mg Gluconate 25.22% by weight, alone or in combination.

It is herein acknowledged that the food additive may additionally comprise any amino acid selected from the group consisting of Alanine, Arginine, Aspartic Acid, Glutamic Acid, Glycine Histidine, Isoleucine, Leucine, Methionine, Phenylalanine, Proline, Serine, Threonine, Tyrosine, Valine or any combination thereof.

It will be appreciated that the preceding embodiments are exemplary and that many other embodiments of the invention are envisaged, the description herein being sufficient disclosure for a person skilled in the art to realize them.

### Tests:

### Taste Test 1 of Salt Substitute 1-5

In this test, the salt substitute of the present invention was used as a table condiment: A sample meal of mashed potatoes was prepared and served to 5 subjects. Each subject received a small control portion of mashed potatoes salted with ordinary table salt and a small portion salted with salt substitutes 1-5. The taste testing was a double blind procedure and the subject were asked to rate the saltiness 1-5, with 5 being the most salty and 1 being the least.

Results are summarized below:

TABLE 3

| Salt | Sub- | Sub- | Sub- | Sub- | Sub- | Sub- |
|---|---|---|---|---|---|---|
| Substitute no. | ject 1 | ject 2 | ject 3 | ject 4 | ject 5 | ject 1 |
| Control | 3 | 4 | 3 | 3 | 4 | 4 |
| Salt | 2 | 3 | 4 | 3 | 3 | 3 |
| Substitute 1 | | | | | | |
| Salt | 4 | 4 | 4 | 5 | 4 | 3 |
| Substitute 2 | | | | | | |
| Salt | 2 | 5 | 4 | 4 | 4 | 5 |
| Substitute 3 | | | | | | |
| Salt | 3 | 5 | 4 | 5 | 5 | 5 |
| Substitute 4 | | | | | | |
| Salt | 5 | 4 | 5 | 4 | 5 | 5 |
| Substitute 5 | | | | | | |

### Taste Test of Salt Substitute of the Present Invention

Salt is used in many cheese making processes, and the following trials were made to assess the efficacy of the salt substitute of the present invention in terms of taste, when incorporated in cheese making.

### Cheese Production—

The cheese was prepared according tea the following steps.

1. Raw milk was calculated from nearby dairy farm
2. Milk was pasteurized when reached 72 C and quickly dropped to 40 C.
3. Starter bacteria (mesophilic), rennet enzyme and CaCl2 were added according to fixed amounts known in Tzfatit cheese protocol,
4. Letting the cheese clot
5. Cutting the cheese twice to drain the whey and strength the curd.
6. Drain all the whey and pull the curd in round molds.
7. Keep the cheeses pressed in the molds and drained over night
8. Dry salting of the cheeses for another day till the cheese becomes homogenized in the salt content. 4 different types of salt replacer formulas were used.
9. Cheese is ready for sensory trial and electronic tongue measurement.

### Electronic Tongue—

The experiment was carried out at the food Sensory Laboratory at Tel Hai College, Israel. The E-tongue model was SA402B from INSENT company in Japan. The device is designed to characterize the taste profile food products and medicines based on the selective attraction of different taste molecules. The device contains a number of sensors that consist of a unique lipid membrane that can bind to taste molecules according to electrical and hydrophobic attractions. Electrical signal is obtained using the existing potentiometer sensor mechanism compared to Reference electrode without membrane. The electronic tongue can measure the following taste attributes: acidity, sweetness, saltiness, bitterness, Umami and astringent. In addition, the instrument allows to measure aftertaste after a brief rinse with water and then repeat the measurement reading to indicate of any remain taste molecules attached to the membrane. The advantages of the electronic tongue is the ability to receive taste detection respect to human perception, the ability to distinguish between products objectively, low sensory threshold for identifying low concentrations of tastes and the possibility of an evaluating of the impact of interactions between molecules.

### Sensors in Use:

1. COO—sensor for negative bitter compound, like iso-alpha acids that exist in beer, coffee.
2. AE1—sensor for astringent and bitter compounds, e.g. tannic acid
3. CT0—sensor for saltiness, such as ions of Na+, Ca2+.
4. AEE—sensor for Umami, sensitive to glutamic acid molecules.
5. CA0—sensor for acidity, detect H+ ions from acids

TABLE 4
Standard values for working sensors

| CA0 | AE1 | C00 | AEE | CT0 |
|---|---|---|---|---|
| −80-+80 | +80-+160 | +80-+160 | −80-+80 | +90-+130 |

### Operation Method Using the Sensors:

A food set of 5 sensors was used in the project (production date—July 2015). The sensors were used in previous work, but a quality check was performed before every trial in order to check the sensors quality against the standard values (mentioned above). The sensors were cleaned between samples and checked to reach stability of 0.5±mV before the actual reading. 4 repetitions were done to each sample. The results were analyzed using Excel 2007 and XLstat statistical software.

Reference solution—used to clean the sensors between the measurements and to stable the reading before sample reading. The solution contains 0.3 mM tartaric acid and 30 mM KCl.

Cleaning solutions—acidic and alkaline solutions with high concentration of HCl and NaOH are used to clean the sensors after sample reading.

Operation Steps Using the Electronic-Tongue (from Left to Right)

| | | | | | | | |
|---|---|---|---|---|---|---|---|
| Rinsing the sensors | Washing the | Washing the | Stability | Sample | Rapid | Rapid | Aftertaste |
| for 120 s in | sensors at reference | sensors at reference | check for the | reading | rinse | rinse | measurement |
| cleaning solutions | solution for 90 s | solution for 90 s | sensors | (30 s) | (3 s) | (3 s) | (30 s) |

### Sensory Evaluation Tests:

A trained panel of 10-15 tasters recruited from Tel Hai College, partly are the college employees and the rest are students. The panel gone through a training period of 2-3 months prior the project to be familiar with the cheese taste attributes of saltiness, bitterness and aftertaste.

The outcome from a sensory panel can provide information regarding the organoleptic quality of the cheese, and the results are given in graphs to be able to compare between samples.

In this project, an intensity test was demonstrated over 4 different salt replacement mixtures that were used to salt the cheese. The tasters were asked to evaluate the intensity perception of saltiness, bitterness and aftertaste using bi-polar scale where the reference in the middle was a cheese with 2.5% NaCl salt (considered normal Tzafatit salt content). The tests were done under controlled condition of temperature, light and humidity. The test results were recorded on-line in tablets

Sensory Evaluation of “Tzaftit” Cheeses with Salt Replacers
1. Goal: to provide a sensorial evaluation of the cheese taste profile (saltiness, bitterness) and likeness of the cheese.

### 2. Materials:

a. Four types of salt replacers given by the company and labeled from 1 to 4.
b. Soft Cheeses—Tzafatit. About 200 gr each. The cheese was evaluated 2 days after production date.

### 3. Sensory Test:

a. 15 tasters were evaluated the cheeses in 2 sessions. Average age—40.
b. Each session of sensory evaluation was taken between 15-20 min
c. The tasters were given unsalted crackers and water between each sample
d. All the tests were done in controlled conditions sensory booths

### 4. Results:

a. Saltiness

The difference in saltiness between the cheeses can be seen in FIG. 4.

### FIG. 4: Saltiness Intensity Ranked by the Sensory Panel

The saltiness intensity of “3” represents the saltiness level of the reference cheese—2.5% NaCl. All the experiment cheeses with the salt mixtures gave a bit higher intensity for saltiness, where mixture number 2 and 4 felt slightly more salty.

b. Bitterness:

### FIG. 5: Bitterness Intensity Ranked by the Sensory Panel

The difference in bitterness between the cheeses can be seen in FIG. 5.

The bitterness intensity of “3” represents the bitterness level of the reference cheese—2.5% NaCl. All the experiment cheeses with the salt mixtures gave a similar bitterness level of a reference cheese. The reference cheese had no significant bitterness sensation.

c. Off-flavor

### FIG. 6: Off-Flavor Ranked by the Sensory Panel Among the Different Cheeses

The off-flavour intensity between the cheeses with different salt mixtures can be seen in FIG. 6. The tasters were asked to rank the off-flavor intensity from 1 (not felt at all) to 5 (strongly felt).

One can see that all the mixtures gave a reasonable low rank of about 2.7 (weakly felt) in average. According to distribution of the intensity of off-flavor, mixture #1 was slightly better felt with 48% of the tasters felt the off-flavor, compared to 60% for the other mixtures.

Electronic Tongue Evaluation of “Tzaftit” Cheeses with Salt Replacers
1. Goal: to provide a digital taste profile of the cheeses with different salt replacers mixtures in comparison with reference cheese of 2.5% NaCl (w/w).

### 2. Method:

a. 20 g of cheese were weighed to a beaker. Two cheeses of each salt replacer type were uses as replicates
b. 80 ml of distilled water at 40 C were added to the cheese
c. Coarse homogenization by stirrer for 1 minute
d. Centrifuge the cheese solution at 4 C at 4200 rpm for 15 min
e. Remove only the liquid from the fat and protein layers. The solution include most of the taste charged molecules for the E-Tongue measurement

### 3. Electronic Tongue Method:

### Instrument: Insent, SA402B, Japan Report: 1003 E.K Salt Ltd.

a. 10 samples of 70 ml were measured. For each cheese sample two replicates were used from two different cheeses.
b. Each measurement include:
1. Cleaning step in cleaning solutions (acidic and alkaline)
2. Washing in reference solution (30 mM KCl and 0.3 mM tartaric acid)
3. Stability measurement to reach ±0.5 mV reading deviation
4. Measurement reading of sample for 30 s
5. Short washing in reference solution
6. After taste measurement (CPA) of sample in reference solution

### 5. Results:

All the cheese samples were measured for pH and conductivity before using the electronic tongue.

TABLE 4
pH and conductivity of cheese samples

| Sample | Conductivity | pH |
|---|---|---|
| 1.1 | 9.4 | 5.34 |
| 1.2 | 5.37 | 5.37 |
| 2.1 | 4.92 | 5.4 |
| 2.2 | 6.73 | 5.63 |
| 3.1 | 9.76 | 5.58 |
| 3.2 | 10.25 | 5.66 |
| 4.1 | 6.26 | 5.38 |
| 4.2 | 6.84 | 5.35 |
| 5.1 (ref) | 8.85 | 5.58 |
| 5.2 (ref) | 9.05 | 5.6 |

### Sensor Check was Performed Before Measurement:

| | | | | |
|---|---|---|---|---|
| AE1 | C.00 | CT0 | CA0 | AEE |
| 90.24 | 97.87 | 90.26 | 61.34 | 34.36 |
| +80 to +160 | +80 to +160 | +90 to 130 | -80 to +80 | -80 to +80 |

The values are in the correct range for the sensors according to manufacture protocol.

### Taste Profile Analysis

The taste profiles between the cheeses can be seen in Table 2 and FIG. 4-5 according to the raw results from the sensors (values are in mV)

TABLE 5
Raw results of taste sensors for the cheese samples.

| cpa(AE1) | cpa(C00) | cpa(AAE) | AE1 | C00 | CA0 | CT0 | AAE | |
|---|---|---|---|---|---|---|---|---|
| −1.34 | 0.98 | 4.25 | −32.06 | −34.24 | −63.93 | −33.61 | −56.75 | ref 1 |
| −0.96 | 1.9 | 4.27 | −32.35 | −33.72 | −63.38 | −34.22 | −56.37 | ref 2 |
| −1.27 | 1.81 | 3.56 | −32.09 | −33.94 | −61.42 | −33.3 | −53.21 | 1.1 |
| −1.15 | −1.46 | 3.36 | −28.08 | −29.62 | −62.12 | −28.03 | −55.08 | 1.2 |
| 0.02 | 0.95 | 3.53 | −27.27 | −28.19 | −62.1 | −26.82 | −55.31 | 2.1 |
| −0.99 | 1.55 | 4.04 | −28.81 | −29.36 | −67.71 | −36.3 | −59.55 | 2.2 |
| −0.54 | 1.19 | 4.47 | −30.88 | −31.48 | −67.31 | −37.9 | −59.1 | 3.1 |
| −0.71 | 1.76 | 4.61 | −32.46 | −32.4 | −67.92 | −40.29 | −59.9 | 3.2 |
| 0.02 | 1.35 | 3.08 | −28.98 | −29.34 | −61.16 | −30.25 | −55.55 | 4.1 |
| −0.62 | 0.91 | 3.59 | −29.62 | −30.18 | −61.31 | −30.22 | −54.89 | 4.2 |

FIG. 7, FIG. 8: Taste Profile of Cheeses (1-4) and Reference Using the e-Tongue Sensors

From the results, one can see that the cheeses are quite similar with their taste values. When looking more carefully in regard to the reference cheese, some differences can be seen most of the sensors. The difference stands around 1 to 8 mV.

### FIG. 9. Taste Perception Values

When converting the values of the raw data from the sensors into taste perception values using algorithms written by the manufacture, the differences between tastes are more clear (FIG. 9)

Each 1 unit in the scale represents a difference in taste that can be recognized by a trained panel. Below 1 unit the difference is not so clear to distinguish.

The results in FIG. 9 point out that the cheese 3 had higher saltiness value by more than 2 units from cheese 1 and 4 and by 1 unit from reference cheese. There is also some differences for the sourness although the pH was quite high above 5, so it is hard to say that any of the cheeses felt sourer than the others. The rest of the tastes gave no significant difference of more than ‘1’ unit.

### 2. Multivariate Analysis Principle Component Analysis (PCA)

The cheeses were plotted on a PCA map to be able to distinguish between the samples according the different sensors used by the E-Tongue (FIG. 10)

FIG. 10. PCA Plot of the Cheese Samples with Replicates.

From FIG. 10. It can be seen that cheese 5 (ref), 4 and 3 replicates are more closely attached in the map compared to cheese 1 and 2. The reason for this deviation is the salt distribution in the cheese that probably was not fully homogenized throughout the cheese. Also we have noticed that some salt remained on the surface of the cheese after a whole day being dry salted in a wrapped plastic bag.

Still it can be seen that cheese with salt replacement mixture number 3 was the closest to the reference according to the main axis X which explain 56.61% of the measurement variations (F1).

### FIG. 11 Influence of the Cheese Taste on the Different Sensors

The sensors output in the PCA plot can be seen in FIG. 11 that show the influence of the cheese taste on the different sensors. Cheese 3 for example is mostly influenced by cpa (AAE) but the least influenced by CT0 (least saltiness).

FIG. 12. PCA Plot of the Cheese Samples with Replicates and Sensor Vectors

Average plot of the cheese samples in FIG. 8 present a more clear understanding to the cheese taste profile according to different salt replacer mixtures. From the results, it may be concluded that using salt replacer #3 provide the closest taste profile to reference cheese (#5), where the cheeses #1 and #4 are slightly different (mainly seen by sensor CT0, CA0 and AAE). In comparison to the reference cheese, cheese #2 and 4 are also differing by positive location in the map according to sensors C00 and AE1. However this difference is on the secondary Y axis that presents only 31.78% of the variation (F2).

### The Sensor Square Cosines are Presented in Table 3:

| F2 | F1 | |
|---|---|---|
| 0.446 | 0.510 | AAE |
| 0.025 | 0.918 | CT0 |
| 0.301 | 0.637 | CA0 |
| 0.526 | 0.449 | C00 |
| 0.289 | 0.646 | AE1 |
| 0.018 | 0.869 | cpa(AAE) |
| 0.001 | 0.328 | cpa(C00) |
| 0.378 | 0.172 | cpa(AE1) |

CT0 sensor has the highest impact on the variation between the samples, followed by cpa (AAE). F1 represents the X axis with the higher variation degree.

FIG. 12. PCA plot of the cheese samples (average) with sensor vectors. The blue arrow represents the distance between close samples of #3 and #5 (ref)

### CONCLUSIONS

1. According to sensory panel, there was no significant difference in saltiness or bitterness between the salt replacements added to the cheese compared to reference cheese with 2.5% NaCl.
2. Slight higher perception in saltiness felt for cheese #1 and #4 compared to the reference
3. The bitterness values were quite low (2-3) and were comparable to the reference cheese
4. Off-flavor notes were hardly noticed to all the cheeses. Cheese #1 was slightly better
5. Using the E-tongue, the result valid the outcome from the sensory panel with very small differences in taste between the cheeses. Cheese #3 seems to be slightly saltier, while the rest of the sensors output show no significant difference in taste between the cheese (values were less than ‘1’ unit)
6. According to PCA plot the overall taste profile: the closest cheese to the taste profile of the reference cheese is cheese #3, and second after is cheese #2. The sensor CT0 reading was the most significant for the variation in the taste profile.

A hygroscopicity study shows the extent to which the salt substitute absorbs moisture. It absorbs 8.5% water in 21 hours (very flat at the end), while the water lost during the dehydration process is 13.75%. The graph and data is provided in FIG. 13

### Trials of the Effect on Blood Pressure of the Salt Substitute of the Present Invention.

Table 2 below is a commonly used Blood Pressure classification, as approved by several recognized authorities including the American Heart Association.

TABLE 2

| Category | Blood Pressure, mm Hg |
|---|---|
| Normal | SBP 90-119 and 60-79 |
| Prehypertension | SBP 120-139 or DBP 80-89 |
| Stage 1 HTN | SBP 140-159 or DBP 90-99 |
| Stage 2 HTN | SBP ≥ 160 or DBP ≥ 100 |

DBP = diastolic blood pressure;
SBP = systolic blood pressure

Five middle aged male subjects with a multiyear history of Stage 2 High Blood Pressure a multi-year history of essential hypertension approximately (180 mmg/100 mmg) used the salt substitute of the present invention without otherwise substantially altering their diet for a period of approximately 3 months.

An average drop of 20 mm Hg (SBP) was noted, and in one of the subjects not only was this drop achieved, the drop of 20 mm Hg in SBP was, combined with reduction of bisoprolol fumarate (Cardiloc) from 10 mg, to 2.5 mg per day.

The above mentioned tables, figures descriptions are non-limiting guidelines of the method, rationale and embodiments of the present invention and are provided such that a person skilled in the art may carry out the present invention, including variants thereof which will become apparent through the present disclosure and are herein disclosed to be nevertheless part of the present invention. It is herein acknowledged that the embodiments described and taught in the present disclosure of the invention are envisaged to be particularly suitable for use in the Dietary Approaches to Stop Hypertension Diet (DASH) and other reduced sodium diets.

1.-33. (canceled)

34. A food additive useful as a table salt substitute in the form of a fine powder of a mixture of salts and acids ratio of Sodium, Potassium, Calcium and Magnesium elements in accordance with the recommended daily allowance for said elements issued by the American Food and Drug Administration wherein said ratio of said elements are by weight percentage: 60.6% Potassium, 19.4% Sodium, 15.5% Calcium, 4.5% Magnesium.

35. The food additive according to claim 34, wherein said weight percentage of any of said elements are about 7% from said weight percentage.

36. The food additive according to claim 34, useful as a table salt substitute in the form of a fine powder of a mixture of salts and acids selected from the group consisting of:
a. Potassium chloride: 89.78, Sodium chloride: 38.15, Calcium chloride: 33.30, Magnesium phosphate: 25.10, Citric acid: 5 proportions by weight;
b. Potassium chloride: 89.78, Sodium chloride: 38.15, Calcium lactate: 32.73, Calcium chloride: 16.65, Magnesium phosphate: 25.10, Citric acid: 5 proportions by weight;
c. Potassium chloride: 89.78, Sodium chloride: 38.15, Calcium chloride: 33.30, Magnesium phosphate: 25.10, Ascorbic acid: 5 proportions by weight;
d. Potassium chloride: 89.78, Sodium chloride: 38.15, Calcium gluconate: 64.50, Calcium chloride: 16.65, Magnesium phosphate: 25.10, Citric acid: 5 proportions by weight;
e. Potassium chloride: 44.89, Potassium tartarate: 136.30, Sodium chloride: 38.15, Calcium gluconate: 64.50, Calcium chloride: 16.65, Magnesium phosphate: 25.10, Citric acid: 5;
f. Potassium chloride: 44.89, Potassium tartarate: 136.30, Sodium chloride: 38.15, Calcium gluconate: 64.50, Calcium chloride: 16.65, Magnesium phosphate: 25.10, Malic acid: 5;
g. Potassium chloride: 89.78, Sodium chloride: 38.15, Calcium gluconate: 64.50, Calcium chloride: 16.65, Magnesium citrate: 30.88, Citric acid: 5;
h. Potassium chloride: 89.78, Sodium chloride: 38.15, Calcium lactate: 32.73, Calcium chloride: 16.65, Magnesium chloride: 29.28, Malic acid: 5; and
i. Potassium chloride: 89.78, Sodium chloride: 38.15, Calcium lactate: 32.73, Calcium chloride: 16.65, Magnesium gluconate: 59.71, Malic acid: 5;
and having taste improvement and palatability similar to table salt as determined by a trained panel of 10 to 15 tasters and further determined by a “Insent, SA402B” electronic tongue (E-Tongue) in comparison with a reference.

37. The food additive according to claim 36, wherein said weight percentage of any of said salts and acids in said mixture are about 7% from said weight percentage.

38. The food additive according to claim 36, wherein said Magnesium phosphate is substituted substantially or in part by any magnesium compound selected in from the group consisting of magnesium citrate, 15.22% by weight, MgCl2.6H2O 14.19% by weight, or Magnesium Gluconate 25.22% by weight alone or in combination.

39. The food additive according to claim 34, wherein said food additive additionally comprises an acid or acids.

40. The food additive according to claim 39, wherein said acids are selected from the group consisting of Citric, Malic and Ascorbic acid.

41. The food additive according to claim 39, wherein said acids are in the amount of about 1 to about 3 weight percent of the entire food additive mixture.

42. The food additive according to claim 34, wherein said mixture additionally comprises any amino acid selected from the group consisting of Alanine, Arginine, Aspartic Acid, Glutamic Acid, Glycine Histidine, Isoleucine, Leucine, Methionine, Phenylalanine, Proline, Serine, Threonine, Tyrosine, Valine or any combination thereof.

43. The food additive according to claim 34, wherein said food additive additionally comprises Iodide or Iodine.

44. The food additive according to claim 34, wherein said food additive is substantially Iodide free or Iodine free.

45. The food additive according to claim 34, wherein said food additive additionally comprises anticaking agents.

46. The food additive according to claim 34, wherein said food additive is substantially free of anticaking agents.

47. The food additive according to claim 34 formulated for application to ready meals, processed meat and meat products, fish and fish products, bacon, ham and salami, cheese and salty snacks.

48. The food additive according to claim 34 formulated for application during cooking in bouillon, stock cubes and the like.

49. The food additive according to claim 34 formulated for application for use as a table salt, soy sauce, fish sauce, meat sauce or ketchup.

50. A method of seasoning a manufactured food product comprising steps of providing a salt substitute in the form of a fine powder of a mixture of salts and acids ratio of Sodium, Potassium, Calcium and Magnesium elements in accordance with the recommended daily allowance for said elements issued by the American Food and Drug Administration wherein said ratio of said elements are approximately, by weight percentage: 60.6% Potassium, 19.4% Sodium, 15.5% Calcium, 4.5% Magnesium; and adding said product to during or after approved manufacturing process of said food product and packaging said product and labeling said product.

51. The method according to claim 50 wherein said step of providing a salt substitute is in the form of a fine powder of a mixture of salts and acids selected from the group consisting steps of:
a. mixing Potassium chloride: 89.78, Sodium chloride: 38.15, Calcium chloride: 33.30, Magnesium phosphate: 25.10, Citric acid: 5 proportions by weight;
b. mixing Potassium chloride: 89.78, Sodium chloride: 38.15, Calcium lactate: 32.73, Calcium chloride: 16.65, Magnesium phosphate: 25.10, Citric acid: 5 proportions by weight;
c. mixing Potassium chloride: 89.78, Sodium chloride: 38.15, Calcium chloride: 33.30, Magnesium phosphate: 25.10, Ascorbic acid: 5 proportions by weight;
d. mixing Potassium chloride: 89.78, Sodium chloride: 38.15, Calcium gluconate: 64.50, Calcium chloride: 16.65, Magnesium phosphate: 25.10, Citric acid: 5 proportions by weight;
e. mixing Potassium chloride: 44.89, Potassium tartarate: 136.30, Sodium chloride: 38.15, Calcium gluconate: 64.50, Calcium chloride: 16.65, Magnesium phosphate: 25.10, Citric acid: 5;
f. mixing Potassium chloride: 44.89, Potassium tartarate: 136.30, Sodium chloride: 38.15, Calcium gluconate: 64.50, Calcium chloride: 16.65, Magnesium phosphate: 25.10, Malic acid: 5;
g. mixing Potassium chloride: 89.78, Sodium chloride: 38.15, Calcium gluconate: 64.50, Calcium chloride: 16.65, Magnesium citrate: 30.88, Citric acid: 5;
h. mixing Potassium chloride: 89.78, Sodium chloride: 38.15, Calcium lactate: 32.73, Calcium chloride: 16.65, Magnesium chloride: 29.28, Malic acid: 5; and
i. mixing Potassium chloride: 89.78, Sodium chloride: 38.15, Calcium lactate: 32.73, Calcium chloride: 16.65, Magnesium gluconate: 59.71, Malic acid: 5;
by providing taste improvement and palatability similar to table salt as determined by a trained panel of 10 to 15 tasters and further determined by a “Insent, SA402B” electronic tongue (E-Tongue) in comparison with a reference.

52. The method according to claim 50, comprising step of selecting said elements in form of salts from the group consisting of Chloride, Phosphate, Lactate, Citrate, Gluconate, Ascorbate, and Tartarate.

53. The method according to claim 50, comprising step of providing at least a portion of said Calcium is in the form of Calcium Lactate.
